(19) United States
(12) Patent Application Publication
(10) Pub. No.: US 2005/0193535 A1
(43) Pub. Date: Sep. 8, 2005

(54) Nestable caskets and containers

(76) Inventors: Gerald H. Davis, Fountain City, IN (US); Gary L. Cox, Richmond, IN (US); Chad L. Eversole, Richmond, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/793,836

(22) Filed: Mar. 5, 2004

(51) Int. Cl. A61G 17/00

(52) U.S. Cl. 27/2

(57) ABSTRACT

A casket assembly for cremation or burial includes a plurality of caskets each having a body and a lid mounted thereon. In one embodiment, the caskets are sized to enclose successively smaller volumes and are nestable with the lids mounted to the bodies. The caskets are sized so that a largest one of the caskets can contain all other ones of the caskets. In another embodiment, nestable boxes are configured to be received within a storage container in a partially folded configuration.

### BACKGROUND OF THE INVENTION

The present invention generally relates to caskets, and more particularly, to caskets that are to be shipped from one location to another or stored for later use.

Caskets for the deceased are made in a wide variety of designs. Very ornate caskets are typically used for burial. Simpler caskets with box-like designs are typically used for cremation. However, simple caskets are also gaining popularity as burial caskets. One reason for the increasing popularity of simple caskets is that their cost is low relative to that of more ornate caskets.

A significant portion of the total cost of a casket is wrapped up in its transportation and storage. Thus, in order to keep the cost of a casket low, it is important to minimize its shipping and storage costs. Both costs are closely related to the amount of space or volume that the casket occupies either in the transporting vehicle or in a storage facility.

Some caskets are designed to be stackable or nestable in order to reduce the space taken by the caskets when they are packaged for shipment or storage. More particularly, the caskets are stacked such that caskets are partially received in other caskets, i.e., a bottom portion of one casket is received through the top opening of another casket. Thus, the total height of the stack of caskets is less than the sum of the heights of the individual caskets that make up the stack, but is, of course, greater than the height of any one of the caskets. Although such stacking of caskets does reduce the space occupied by the caskets, these stacks can be inherently unstable and at risk of toppling over. Another problem is that the stackability requirement limits the designs of the caskets.

Accordingly, there is a need for caskets that can shipped and stored in a compact, stable package, thereby reducing transportation and storage costs.

### SUMMARY OF THE INVENTION

In accordance with one aspect of the present invention, there is provided a set of caskets wherein each casket has a different size. The smallest casket is completely contained within the second smallest casket, which is completely contained within the third smallest casket, and so on, until the largest casket completely contains all other caskets in the set.

The present invention comprises, in one embodiment thereof, a casket assembly for cremation or burial. The casket assembly includes a plurality of caskets each having a body and a lid. The caskets are sized to enclose successively smaller interior volumes and are nestable such that a largest one of the caskets can contain all other ones of the caskets, preferably including the body and lid of all of the other caskets. In certain embodiments, the lids of the other ones of the caskets each have a respective outer width that is substantially equal to an inner width of the body of a next-larger-sized one of the caskets.

The present invention comprises, in another embodiment thereof, a casket packaging method for caskets intended for cremation or burial. A plurality of caskets is provided, each including a body and a lid. The caskets are sized to enclose successively smaller interior volumes. One of the bodies is nested into a next larger one of the bodies. One of the lids is coupled to a respective one of the bodies.

In another embodiment, nestable boxes can include foldable cardboard bodies and lids, such as a disposable casket. The nestable boxes are stored within another container with the side walls of the boxes at a non-perpendicular, non-coplanar angle relative to the bottom wall of the boxes. The boxes are nested within each other with the side walls at this particular angle, thereby saving space and adding to the overall integrity of the nested boxes.

An advantage of the set of caskets of the present invention is that one casket can completely contain multiple other caskets, thereby saving valuable shipping and storage space. Another advantage is that the caskets can be packaged in a very stable configuration that is much less susceptible to toppling over during shipping than prior assemblies.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exploded, perspective view of one embodiment of a set of caskets of the present invention in a first packaging arrangement;

FIG. 2 is a perspective view of the caskets of FIG. 1 in their packaged state, ready for shipping or storage;

FIG. 3 is a fragmentary, cross-sectional view of the set of caskets of FIG. 2 along line 3—3;

FIG. 4 is an exploded view of the set of caskets of FIG. 1 in a second packaging arrangement;

FIG. 5 is a fragmentary, cross-sectional view, similar to FIG. 3, of the set of caskets in the arrangement of FIG. 4;

FIG. 6 is an exploded view of the set of caskets of FIG. 1 in a third packaging arrangement;

FIG. 7 is a fragmentary, cross-sectional view, similar to FIGS. 3 and 5, of the set of caskets in the arrangement of FIG. 6; and

FIG. 8 is a perspective view of a nested container set in accordance with a further embodiment of the invention.

FIG. 9 is a top elevational view of the container set shown in FIG. 8.

FIG. 10 is a cross-sectional view of the container set shown in FIGS. 8-9 taken along line D-D as viewed in the direction of the arrows.

FIG. 11 is a side elevational view of the container set shown in FIG. 8.

FIG. 12 is a perspective view of a blank of a container lid for the container set shown in FIG. 8.

FIG. 13 is a perspective view of a side panel of the container set shown in FIG. 8.

FIG. 14 is a perspective view of a nestable box shown in its partially folded configuration in accordance with one aspect of the present invention.

FIG. 15 is an end view of a plurality of the partially folded boxes depicted in FIG. 14, shown in a nested arrangement according to the present invention.

### DESCRIPTION OF THE PREFERRED EMBODIMENTS

The exemplifications set out herein illustrate preferred embodiments of the invention, and such exemplifications are not to be construed as limiting the scope of the invention in any manner.

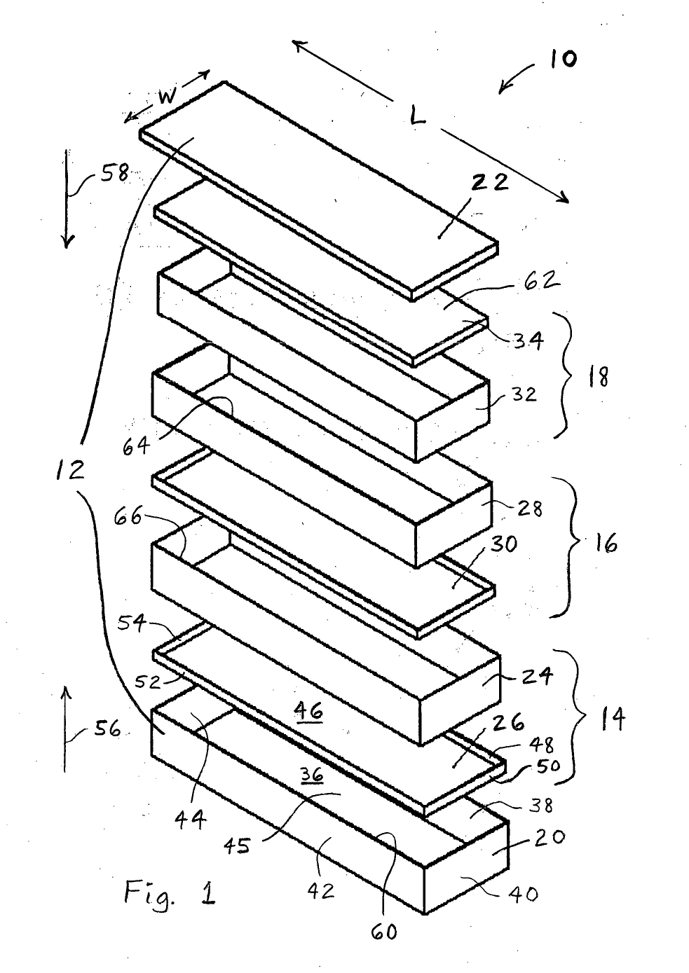

Referring now to the drawings, and more particularly to FIG. 1, a first packaging arrangement of an exemplary set 10 of caskets constructed according to principles of the present invention is shown. For purposes of example and explanation, the set 10 is shown to include four caskets 12, 14, 16 and 18 although the sets can include any number of caskets greater than one.

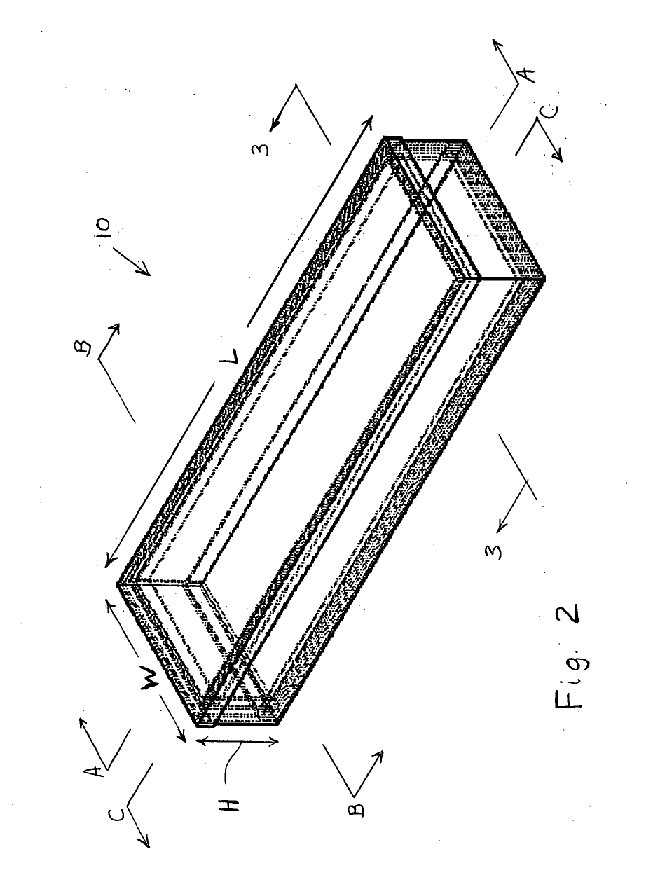

The caskets 12, 14, 16 and 18 are each provided with a different size, each enclosing a successively smaller interior volume. The caskets are sized such that they can be nested one into another. More particularly, the largest casket 12 can completely contain the second largest casket 14; the casket 14 can completely contain the third largest casket 16; and casket 16 can completely contain the smallest casket 18. Thus, when the caskets 12, 14, 16 and 18 are so packaged, the largest casket 12 can completely contain all of the other caskets 14, 16 and 18 simultaneously, as shown in FIG. 2.

The caskets 12, 14, 16 and 18 are rectangular and are progressively smaller in terms of height H, width W and length L. Because the sizes of deceased persons have some variance, providing caskets of various sizes does not take away from the utility of the set, and may, in fact, add to the utility of the set 10 of caskets by allowing a deceased person to be matched with an appropriately sized casket.

Each of the caskets 12, 14, 16 and 18 is typically made of an inexpensive wood or wood product, such as pine wood or particleboard. However, the caskets 12, 14, 16 and 18 can also be made of any other material suitable for burial or cremation within the spirit and scope of the present invention. In some applications, the body and lid of the caskets can be formed of a fibrous material, such as corrugated cardboard.

Each of the caskets 12, 14, 16 and 18 includes a lid and a body in the form of a box. More particularly, the casket 12 includes a box 20 and a lid 22; the casket 14 includes a box 24 and a lid 26; the casket 16 has a box 28 and a lid 30; while a box 32 and a lid 34 make up casket 18.

Each of the bodies has a planar, rectangular base and four upstanding walls attached along the peripheral edges of the base. The distal edges of the walls define an open top of the body. For example, the body 20 has a base 36 and upstanding walls 38, 40, 42, 44 defining an open top 45. Each of the walls is oriented substantially perpendicular to its corresponding base.

Each of the lids has a planar, rectangular panel and four upstanding flanges attached along the peripheral edges of the panel. Each of the flanges is oriented substantially perpendicular to its corresponding body. For example, the lid 26 has a body 46 and upstanding flanges 48, 50, 52, 54. The panel of each lid has the same width W and length L as its corresponding box as measured between the outer surfaces of the walls of the box. Thus, the panel of the lid can rest upon the top edges of the walls of the body, thereby covering the open top of the body. For example, in FIG. 1, the lid 34 is positioned to be lowered onto the body 32, thereby covering the open top of the body 32. In the embodiment shown, the opposite flanges 48, 52 and 50, 54 of the lid are spaced apart widely enough that the panel of the lid can rest upon the walls of the body without interference from the flanges. However, it is also possible, to configure the casket such that the panel of the lid does not engage the walls of the body when the lid covers the open top of the body.

As an alternative to being placed on top of the body and covering the open, the lid can also be placed on the bottom of the body such that the panel of the lid engages the base of the body and/or the proximal edges of the walls of the body. For example, in FIG. 1, the body 28 can be positioned to be lowered into the lid 30. It should be noted that, in the illustrated embodiment the lids 26 and 30 are oriented upside-down relative to the right-side-up orientations of the lids 22 and 34. That is, the flanges of the lids 26 and 30 project from their respective lid panels (46) in an upward direction 56, while, in contrast, the flanges of the lids 22 and 34 project from their respective lid panels (22) in a downward direction 58.

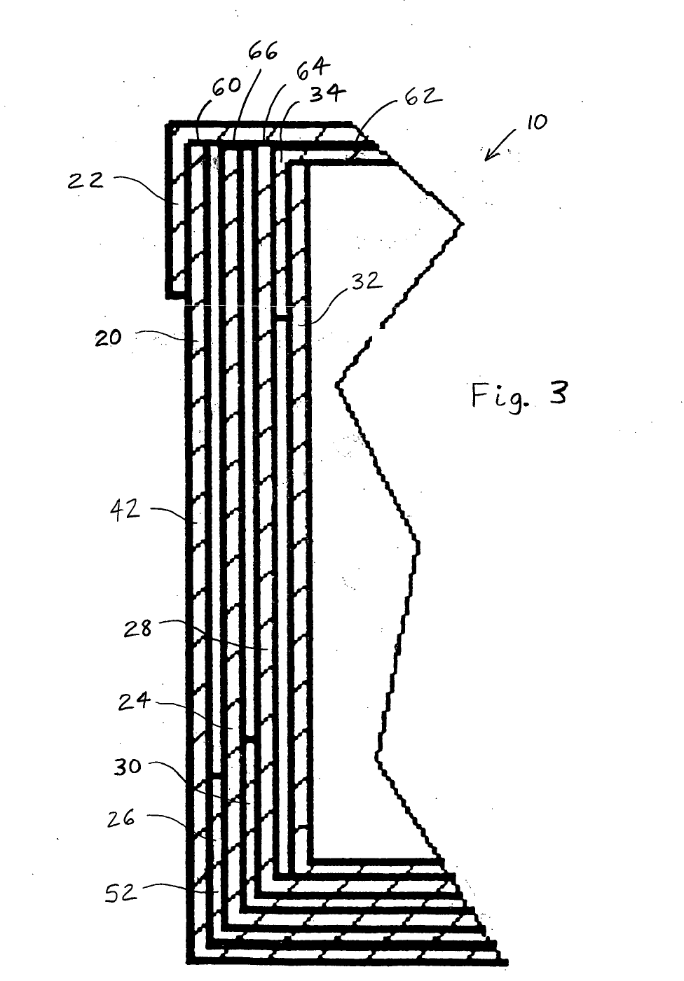

When the caskets are completely nested, the flanges of the lids engage and become sandwiched between the walls of the boxes, as shown in FIG. 3. More particularly, a flange of the lid 34 is sandwiched between the outside of a wall of the body 32 and the inside of a wall of the body 28; a flange of the lid 30 is sandwiched between the outside of a wall of the body 28 and the inside of a wall of the body 24; the flange 52 of the lid 26 is sandwiched between the outside of a wall of the body 24 and the inside of the wall 42 of the body 20; and an inside surface of a flange of the lid 22 engages the outside of the wall 42 of the body 20.

In the embodiment of FIG. 3, there is only minimal clearance between the lids 22, 26, 30 and 34 and their associated bodies 20, 24, 28 and 32. In certain embodiments, the inner surfaces of the flanges of the lids 22, 26, 30 and 34 can be in physical contact with the outer surfaces of the walls of the associated bodies 20, 24, 28 and 32.

In the embodiment of FIG. 3, there is also only minimal clearance between the lids 26, 30 and 34 and the respective bodies 20, 24 and 28 of the next-larger-sized caskets. In certain embodiments, the lid 26 of the casket 14 can have an outer width and outer length approximately equal to the inner width and inner length of the body 20 of the next larger casket 12. Similarly, the lid 30 of the casket 16 can have an outer width and length approximately equal to the inner width and length of the body 24 of the next larger casket 14, and likewise with respect to the lid 34 and body 28 of the casket 18. However, it is to be understood that it is also possible for there to be clearance or gaps between any of the lid flanges and any of the adjacent body walls on the width and/or length.

It can be seen in FIG. 3 that no portion of the caskets 14, 16, 18 extends higher than a distal edge 60 of the wall 42 of the body 20 of the largest casket 12. Rather, a top surface 62 of the body of the lid 34, a distal edge 64 of the body 28, and a distal edge 66 of the body 24 are all at or nearly at the same height or vertical level as the distal edge 60 of the body 20. Thus, the lid 22 of the largest casket 12 can engage and rest upon the distal edge 60 of the wall 42 of the body 20 just as the lid 22 would if the casket 12 were empty. Each of the caskets 14, 16, 18 preferably has an outer height (fort e body and lid) that is nearly equal to an inner height of the respective next-larger-sized one of said caskets 12, 14, 16. In a specific example, the casket walls are 0.5 inches thick and have eights of 11.5, 12.0, 12.5 and 12.75 inches. The lesser height for the smallest casket 18 does not appreciably change its functionality, but does dictate use for a smaller person.

In the embodiment of FIG. 3, the lids 26, 30 of the caskets 14, 16 are placed on the bottoms of their respective bodies, and the lid 34 of the casket 18 is placed on the top of its respective body. In other embodiments, the lids 26, 30, 34 can be placed on the tops or bottoms of their respective bodies in different combinations. Regardless of whether any of the respective lids 26, 30, 34 are placed on the top or the bottom of their respective bodies 24, 28 and 32, no portion of these caskets 14, 16, 18 extends higher than a distal edge 60 of the wall 42 of the body 20 of the largest casket 12.

Cross-sectional views through each of the other three sides of the nested combination of caskets 12, 14, 16, 18 would appear substantially similar to the cross-sectional view of FIG. 3. That is, fragmentary cross-sectional views along the lines A-A, B-B and C-C in FIG. 2 would all appear substantially similar to the fragmentary cross-sectional view of FIG. 3.

In certain embodiments, the lids and/or walls of the interior caskets can project higher than the wall of the box of the next largest or largest casket when the caskets are nested. In other words, the overall height of an interior casket, body and lid together, may be greater than the height of the next largest box. That is, it is possible for the box of the largest casket to only partially contain rather than completely contain the other caskets and still retain many of the advantages of the present invention, such as reduced space requirements. In such a design, the lid of the largest casket may not be fully seated on the box of the largest casket, as it would if there were no interior caskets.

In one specific embodiment, the smallest body 32 has a length of 75 inches, a width of 21 inches and a depth of 10.5 inches, while the next larger body 28 has a length of 76 inches, a width of 22 inches and a depth of 11 inches. The next two larger bodies have corresponding dimensions of 78″×23″×11.5″ and 79″×24″×11.75″. In the illustrated embodiments, only four caskets are combined, which is preferable since any added nested caskets may necessarily be too small or too large to be practical.

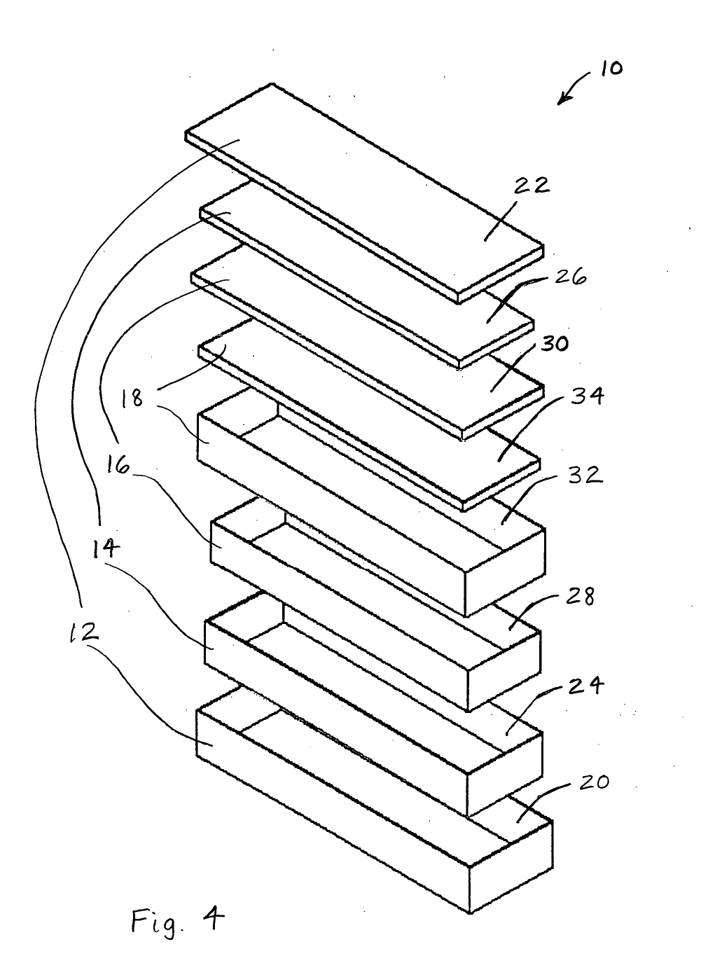

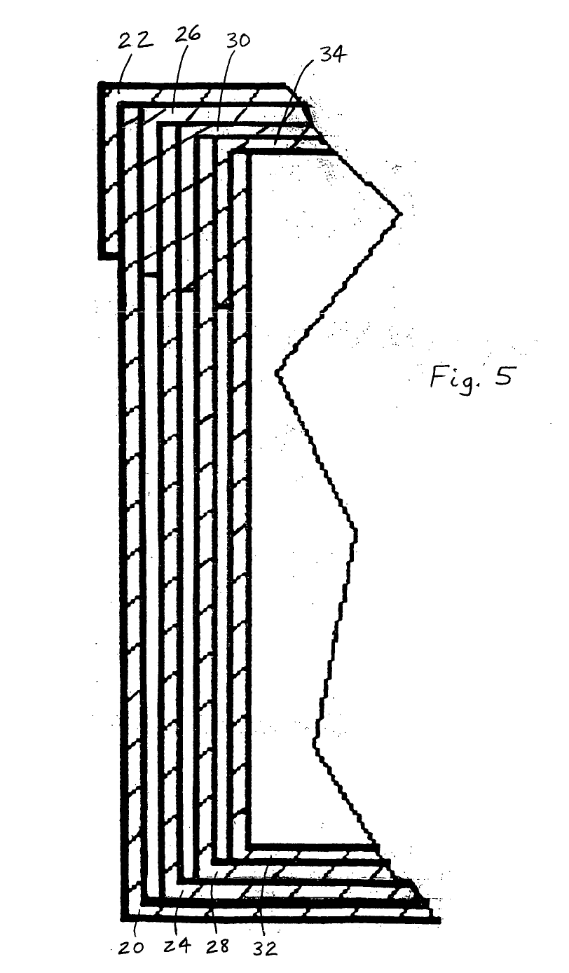

FIGS. 4-5 illustrate the set 10 of caskets configured in a second packaging arrangement according to the present invention. In this arrangement, each lid is disposed on top of its respective body to thereby cover the open top of the respective body. More particularly, the smallest lid 34 is placed on top of the smallest body 32, the second smallest lid 30 is placed on top of the second smallest body 28, and so on for the lids/bodies 26/24 and 22/20, respectively.

As can be seen in a comparison of the arrangements of FIGS. 4-5 with that of FIGS. 1-3, the second arrangement of FIGS. 4-5 occupies no more space than does the first arrangement. That is, both arrangements of the set 10 occupy no more space than does the largest casket 12 by itself.

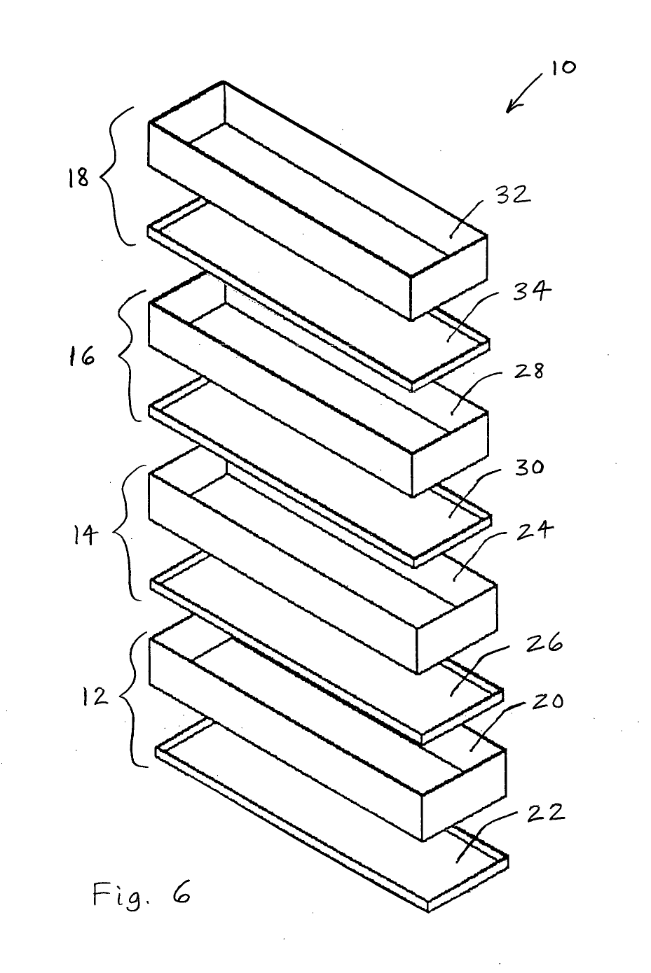

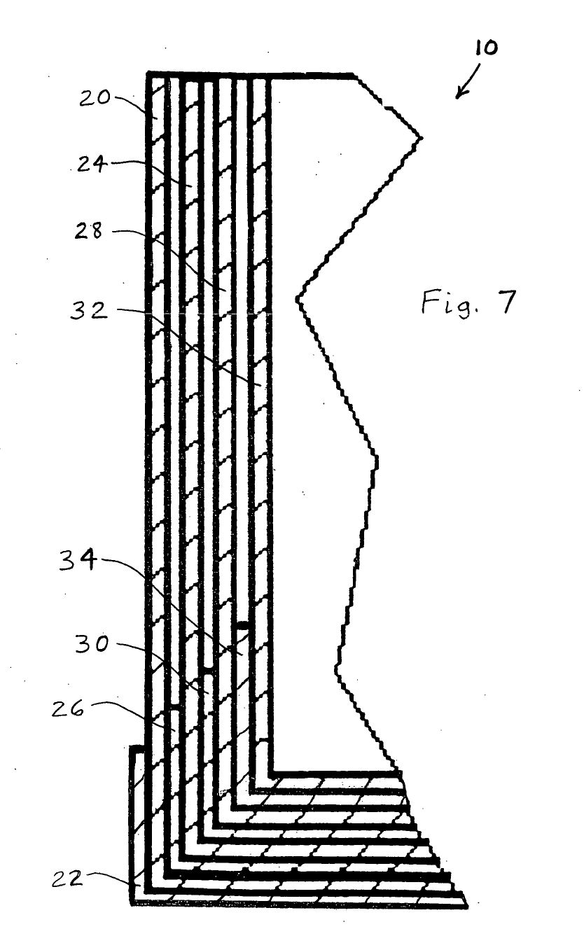

FIGS. 6-7 illustrate the set 10 of caskets configured in a third packaging arrangement according to the present invention. In this arrangement, each lid is coupled to the bottom of its respective body. For example, the smallest lid 34 is placed on the bottom of the smallest body 32, and so forth for the remaining lids and bodies. This third arrangement occupies no more space than the previously described arrangements.

FIGS. 1, 4 and 6 illustrate just three of sixteen different packaging permutations in which the illustrated set of four caskets can be configured. Since each of the four caskets can be arranged with its lid in either of two positions (i.e., on top of the body or on the bottom), the number of possible packaging arrangements exceed the three example embodiments. The dimensions of each of the sixteen packages are the same as the dimensions of the largest casket by itself (i.e., when it does not contain any other caskets). Thus, regardless of which of the sixteen packaging arrangements is employed, the set 10 of caskets provides the same space-saving advantages. Further, because each of the sixteen packing arrangements has the same final size, the assembly process is simplified and made more flexible since each of the lids may be placed on either the top or the bottom of its respective body.

Packaging arrangements similar to that shown in FIG. 6 provide advantages over the other illustrated arrangements. One such advantage is that the open top of the smallest body 32 is left uncovered. This makes the interior of the body 32 available to store other items that are to be included in the same shipment. Another advantage is that this packaging arrangement has a lower center of gravity than the other arrangements. Thus, the packaging arrangement of FIG. 6 may be the most stable and the least likely to topple during shipping.

Yet another advantage is that the packaging arrangement of FIG. 6 may be the easiest of the various arrangements to unpack. As best seen in FIG. 7, with the lids all placed at the bottoms of their respective bodies, it is possible for unpacking personnel to grip the distal ends of the bodies 24, 28, 32 by placing their fingers or tools on both the inside and the outside of the distal ends of the bodies 24, 28, 32. With the distal ends of the bodies so gripped, the unpacking personnel can lift each of the boxes in sequence out of the respective next-larger-sized box. If any of the lids does not remain coupled to its respective body as the box is lifted, then the lid will be carried out during removal of the next-larger-sized box and can be easily removed by turning box upside down.

On possible disadvantage of the packaging arrangement of FIG. 6 is that the lid 22 of the largest casket 12 is at the bottom of the corresponding box 20, leaving the top of the casket open and the nested caskets exposed. This disadvantage can be readily remedied by placing the lid 22 on the top of the casket box 20, thereby completely closing the nested arrangement. Again, this modification can be made without any change to the overall package dimensions.

It should be noted that it is also possible to stack nested groups of caskets on top of one another. Such a stack of the caskets of the present invention is much more stable than a stack of prior art caskets of a comparable height. Further, the present invention enables more caskets to be included in a stack of a given height.

An alternative embodiment of the invention is illustrated in FIGS. 8-15. In this embodiment, the nestable containers are foldable containers, such as disposable caskets. These containers are preferably formed of a paperboard or cardboard material that is corrugated for strength. The containers are provided in a knocked down form, and then folded and adhered into the particular shape, such as a casket. These knock-down containers are light-weight and therefore easy to transport. However, one problem with prior knock-down containers is that they are stored and transported as flattened planar blanks. Thus, a stack of these flattened blanks occupies an area at least equal to the area of the unfolded blank. Any space savings achieved by the minimal height of the stacked blanks is frustrated by the significant area occupied by the stack. Typically in transport and storage, lateral dimensions, such as width and length, are at a premium. Moreover, the height at which the planar material can be stacked is usually limited by the strength of the container because of the weight of the stack.

In order to overcome these deficiencies in the prior art, the present invention contemplates a nested container set 50 that includes a storage container 52 configured to house several nested boxes 70 and their associated lids 72, as depicted in FIGS. 8-10. The storage container is preferably formed of the same material as the nestable boxes. In the illustrated embodiment, these components are formed of corrugated cardboard, such as 350-pund test double-wall cardboard. These components will have a nominal material thickness t (FIG. 15) of about 0.20 inches. The lids 72 may be formed of the same material or a lesser strength material, such as 275-pund test, single wall corrugated cardboard.

The storage container includes a pair of side panels 53, as seen in FIGS. 10-11. Each side panel 53 can be configured as shown in FIG. 13 in which the panel includes a crease score 54 that separates an end panel 55 from the side panel on the same strip of material. The side panels 53 can be initially provided in their un-folded shape as a single planar strip of cardboard, and then folded at the crease score 54 when the storage container 52 is to be assembled.

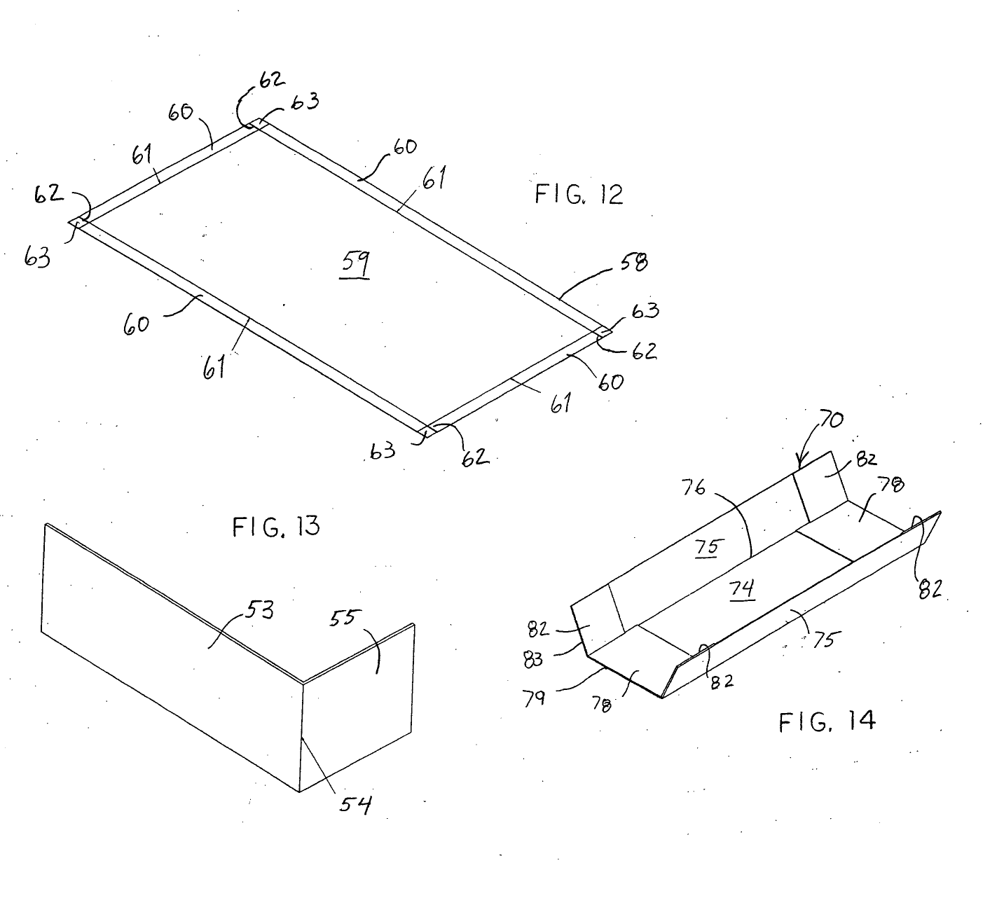

The storage container 52 also includes identically configured top and bottom lids 58 (FIG. 11) that are themselves formed from an originally planar sheet of material, as shown in FIG. 12. Each lid 58 includes a panel 59 flanked on its perimeter by flanges 60. The lid includes crease scores between the panel and each of the flanges so that the flanges can be folded upward to form the lid shape. Each corner of the lid includes a slit 62 that allows a folded corner piece 63 to overlap an adjacent flange.

The storage container 52 is assembled in a known manner. In particular, a top and bottom lid 58 is constructed by folding the flanges 60 along the crease scores 61. Each corner piece 63 overlaps a portion of the flange on the opposite side of the slit 62. The corner pieces 63 can be affixed to the flanges 60 to complete the lid 58, using glue, staples or other known means for fastening. One assembled lid 58 is positioned with the flanges 60 facing upward, and two L-shaped side panels 53 are mounted within the lid, with each side panel 53 and end panel 55 in contact with a folded flange 60. The side panels can be affixed to the bottom lid using glue, staples or other suitable means for fastening. The resulting storage container 52 is now ready to receive the nested boxes 70 and lids 72.

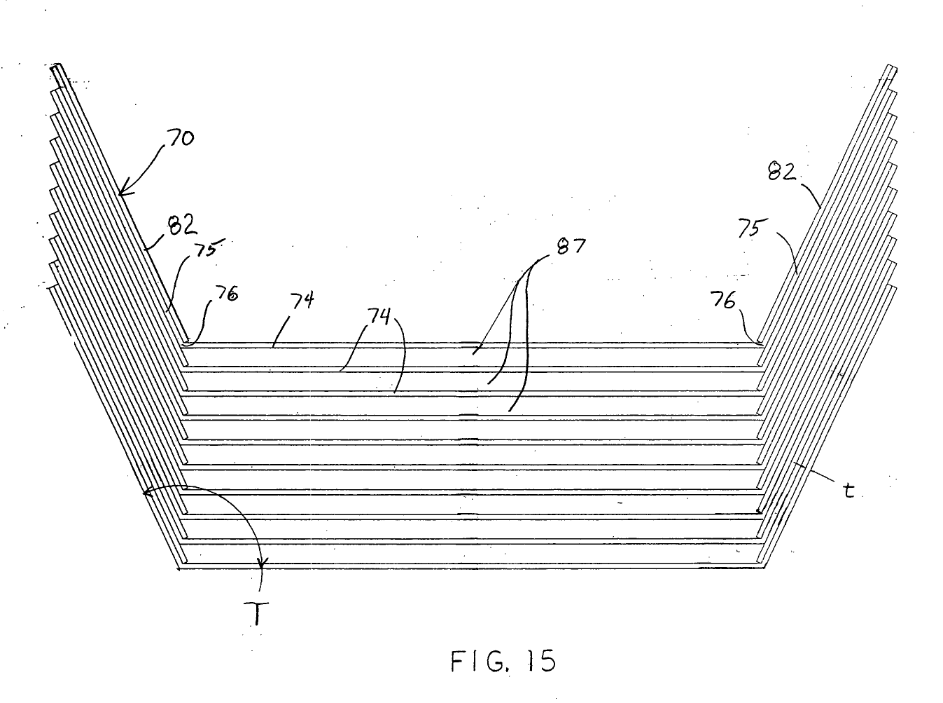

In a preferred embodiment, the lids 72 are initially provided as a planar unfolded panel, substantially similar to the transport lid 58 shown in FIG. 12. In fact, the casket box lid 72 can be identical to the transport lid 58 except in dimension, with the box lid being smaller in width and length. Each nestable box 70 follows a similar pattern in its unfolded state, with some modifications. In particular, as shown in FIG. 14, each box 70 includes a bottom wall 74 with integral side walls 75 and end walls 78. Crease scores 76 separate the side walls from the bottom wall, while crease scores 79 separate the end walls from the bottom wall. Each side wall 175 includes a crease score 83 at each long end of the panel that defines end flaps 82 similar to the corner pieces 63 described above.

The nestable box 70 can be assembled in the same manner as the storage container described above. The end walls 78 have a height greater than the height of the side walls 75 so that the top portion of the end walls 78 can be folded over the end flaps 82 when they are turned inward and affixed to the inside of each end panel. Appropriate crease scores can be provided on the top portion of the end walls 78 to facilitate this folding.

The nestable boxes 70 and their associated lids 72 are retained in their unfolded configuration for placement in a formed storage container 52. Preferably, the planar unfolded blanks for the lids 72 are stacked within the bottom lid 58 of the storage container 52, as shown in FIG. 10. Next, the nestable boxes 70 can be stacked on top of the lids, with the unfolded boxes in the configuration shown in FIGS. 14 and 15. In particular, the end walls 78 are folded inward against the bottom wall 74. Furthermore, the side walls 75 of the boxes are arranged at an angle T relative to the bottom wall 74 for each box, as best seen in FIG. 15. The free edges of the side walls 75 are folded upward slightly and bear against the inside of the side panels 53 of the storage container, as shown in FIG. 10. The side walls are oriented non-coplanar and non-perpendicular with the bottom wall 74 (i.e., the angle T ranges between 90-180 degrees). In accordance with the invention, the angle T is between 110-130 degrees, while a most preferred angle T is about 115 degrees. This angle optimizes the envelope surrounding the nested boxes by: 1) reducing the plan view dimensions from what they would be if the un-folded boxes were stacked; and 2) keeping the overall height of the nested partially folded boxes to a manageable dimension. In addition, the angle of the side walls 75 and the fact that the walls bear against the side panels of the storage container adds to the strength and stability of the nested boxes 70 and the overall container set 50. Moreover, the angle T is not so great that the side walls become susceptible to buckling as the stack of nested boxes shifts during shipment.

A further benefit of the partially folded orientation of the side walls 75 is that when successive boxes 70 are stacked, a gap 87 is left between the bottom walls 74 of the boxes. This additional space provided by the gap 87 is without any significant increase in the overall height of the container set 50. This gap 87 can accommodate nested boxes in which the bottom wall 74 is augmented with a stiffening element. For instance, where the box is intended as a disposable casket, a wood bottom may be added to the bottom wall of the cardboard box. This gap 87 can be about 0.75 inches to account for a typical plywood reinforcement panel.

In the embodiment shown in FIGS. 8, 10 and 15, ten nestable boxes 70 are stacked within a storage container 52. The boxes can be dimensioned for use as a disposable casket. For instance, the width of the bottom wall is 23.0 inches and the length 76.0 inches. The side walls can have a height of 12.0 inches. When ten disposable caskets are stacked in the configuration shown in FIG. 15, the overall height of the stack does not exceed 20.0 inches. A stack of ten unfolded lids 72 will have a height of 2.0 inches (where each lid is 0.20 inches thick), so that the overall height of the storage container 52 can be less than 25.0 inches.

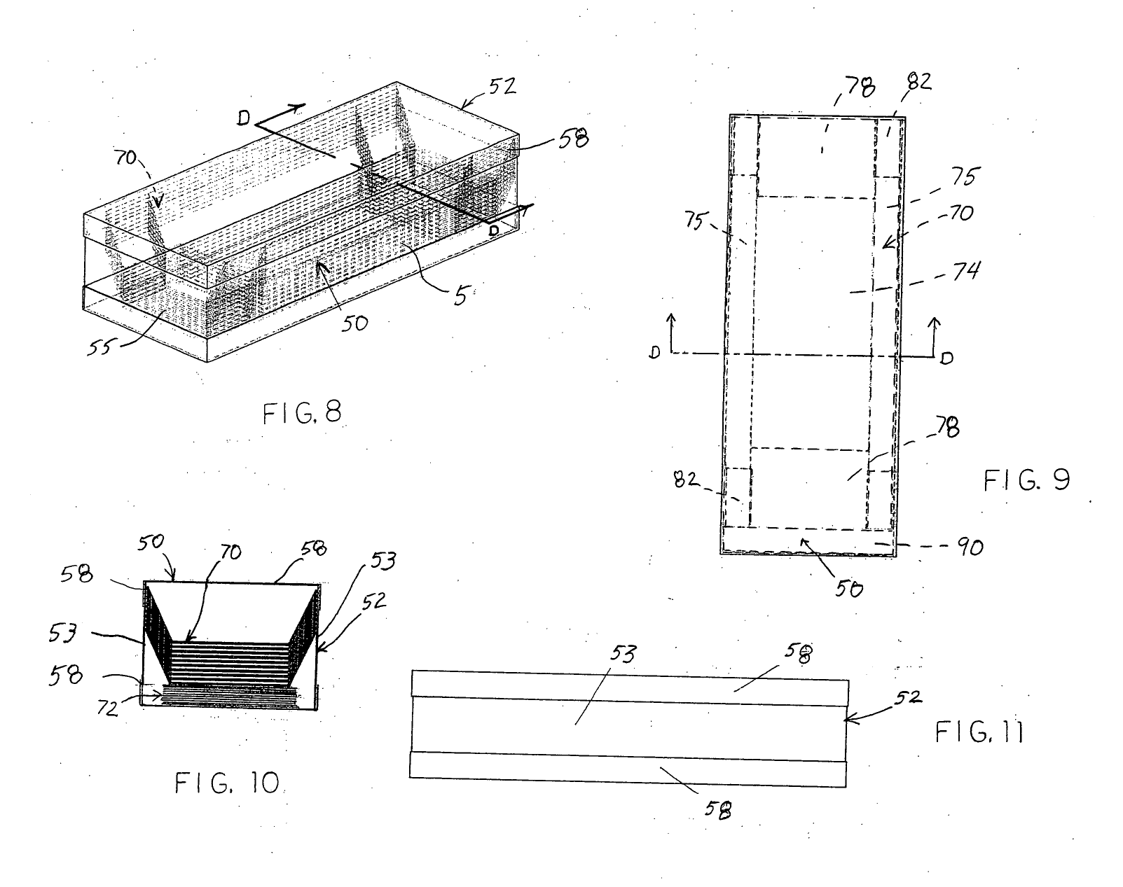

The length of the storage container 52 can be slightly longer than the length of the nestable boxes 70. Alternatively, the storage container can be longer than the partially folded box 70 to provide a storage space 90 at one end of the storage container, as depicted in FIG. 9. This space 90 can be used to store various components for use with the nestable boxes, such as bags, wire ties, etc.

As described herein, the present invention advantageously decreases the transportation and storage costs associated with a set of nestable boxes, such as disposable caskets. While this invention has been described as having a preferred design, the present invention can be further modified within the spirit and scope of this disclosure. This application is therefore intended to cover any variations, uses, or adaptations of the invention using its general principles. This application is intended to cover such departures from the present disclosure as come within known or customary practice in the art to which this invention pertains and which fall within the limits of the appended claims.

1. An assembly of caskets for use in cremation and/or burial, said casket assembly comprising a plurality of successively larger caskets, each of said caskets including a body and a lid mounted on the body, and each of said plurality of caskets sized to be substantially completely contained within the body of a next larger one of said plurality of caskets.

2. The casket assembly of claim 1, wherein said body of a largest one of the caskets is sized to completely contain all other ones of the plurality of caskets.

3. The casket assembly of claim 1, wherein said lid of at least one said of said plurality of caskets has an outer width substantially equal to an inner width of said body of a next larger one of said caskets.

4. The casket assembly of claim 3, wherein said lid of said at least one of said plurality of caskets has an outer length substantially equal to an inner length of said body of the next larger one of said caskets.

5. The casket assembly of claim 3, wherein at least one of said plurality of caskets has an outer height substantially equal to an inner height of a next larger one of said caskets.

6. The casket assembly of claim 1, wherein at least one of said plurality of caskets has an outer height substantially equal to an inner height of a next larger one of said caskets.

7. A method for packaging caskets intended for cremation or burial, said method comprising the steps of:
providing a plurality of caskets each including a body and a corresponding lid mountable on the body, said caskets being sized to enclose successively smaller volumes;
nesting a body into a next larger one of the bodies; and
coupling a corresponding lid to the body.

8. The method of claim 7, wherein said nesting step is repeated until a largest one of the bodies contains all other ones of the bodies.

9. The method of claim 8, wherein said coupling step occurs after the last one of the bodies has been nested.

10. The method of claim 9, wherein said coupling step is repeated until the lid is coupled to the largest one of the bodies.

11. The method of claim 7, wherein said coupling step is performed before the body is nested.

12. The method of claim 11, wherein said coupling steps include placing at least one of the lids on the bottom of the body.

13. The method of claim 12, wherein said coupling steps include placing at least one other of the lids on the top of a respective one of the bodies.

14. The method of claim 7, wherein said steps of nesting the bodies and coupling the lids are sequentially interspersed.

15. A casket assembly for one of cremation and burial, said casket assembly comprising a plurality of differently sized caskets each including a body and a lid, said caskets being nestable such that a largest one of the caskets can completely contain said body and said lid of all other ones of the caskets.

16. A casket assembly for one of cremation and burial, said casket assembly comprising a plurality of caskets each including a body and a lid mounted thereon, said caskets being sized to enclose successively smaller volumes, said caskets being nestable such that a largest one of the caskets can contain all other ones of the caskets, said lids of said other ones of the caskets each having a respective outer width substantially equal to an inner width of said body of a next larger sized one of said caskets.

17. The casket assembly of claim 16, wherein said lids of said other ones of the caskets each has a respective outer length substantially equal to an inner length of said body of a next-larger-sized one of said caskets.

18. The casket assembly of claim 16, wherein each of said other ones of the caskets has a respective outer height substantially equal to an inner height of a next-larger-sized one of said caskets.

19. The casket assembly of claim 16, wherein at least one of said lids is coupled to a bottom of a respective said body.

20. The casket assembly of claim 16, wherein said caskets are nestable such that dimensions of said largest one of the caskets while said largest one of the caskets contains said all other ones of the caskets are substantially equal to dimensions of said largest one of the caskets while said largest one of the caskets contains none of said other ones of the caskets.

21. An assembly of caskets for use in cremation and/or burial, said casket assembly comprising a plurality of caskets, each including a body and a lid mounted thereon, each of said plurality of caskets sized to enclose successively smaller interior volumes, with a largest one of said plurality of caskets enclosing an interior volume sufficient to completely contain all other ones of the plurality of caskets.

22. The casket assembly of claim 21, wherein successively smaller ones of said plurality of caskets enclose an interior volume sufficient to completely contain all other smaller ones of said plurality of caskets.

23. The casket assembly of claim 21, wherein each of said plurality of caskets has an outer height and an inner height that is substantially equal to the outer height of a next successively smaller casket.

24. A assembly of caskets for storage and/or shipment of the caskets, comprising three or more caskets, each including a body and a lid mounted thereon, and each defining a successively larger interior volume, said three or more caskets stacked in a nested arrangement.

25. The assembly of caskets of claim 24, wherein at least one of the three or more caskets has its lid mounted to the top of the body.

26. The assembly of caskets of claim 25, wherein all of the three or more caskets has its lid mounted to the top of the body.

27. The assembly of caskets of claim 24, wherein at least one of the three or more caskets has its lid mounted to the bottom of the body.

28. The assembly of caskets of claim 27, wherein the largest one of the three or more caskets has its lid mounted to the top of the body.

29. An assembly of nestable boxes for storage and/or shipment of the boxes comprising:
a plurality of first pre-formed planar blanks each having a planar bottom wall, opposite side walls and opposite end walls, and each configured to be folded into one of the nestable boxes; and
a container configured to support said plurality of first planar blanks nested one on top of another, and sized to receive said plurality of blanks only with the opposite side walls of said first blanks oriented at a non-perpendicular and non-coplanar angle relative to said planar bottom wall.

30. The assembly of nestable boxes of claim 29, wherein said angle is between 110-130 degrees.

31. The assembly of nestable boxes of claim 30, wherein said angle is about 115 degrees.

32. The assembly of nestable boxes of claim 29, further comprising a plurality of second pre-formed planar blanks, each configured to be folded into a lid for a corresponding one of the plurality of nestable boxes, said plurality of second blanks supported in a stack within said container, each in an unfolded planar configuration, beneath said plurality of first planar blanks.

33. The assembly of nestable boxes of claim 29, wherein said plurality of first blanks are nested one on top of the other and defining a gap between said bottom walls of adjacent blanks.
